(19) United States
(12) Patent Application Publication
(10) Pub. No.: US 2010/0149813 A1
(43) Pub. Date: Jun. 17, 2010

(54) CFL Color Sleeve

(76) Inventor: Rachael Powell, New York, NY (US)

Correspondence Address: Kane Kessler P.C., 1350 Avenue of the Americas, 26th Floor, New York, NY, 10019, US

(21) Appl. No.: 12/639,486

(22) Filed: Dec. 16, 2009

Related U.S. Application Data
(60) Provisional application No. 61/138,214, filed on Dec. 17, 2008.

(51) Int. Cl. F21V 14/00

(52) U.S. Cl. 362/255

(57) ABSTRACT

A lamp sleeve for changing the hue of light emanating from a CFL lamp includes a conical side wall having an inner end inner end opening sized to receive therethrough only the base of the CFL and an outer end opening sized to receive therethrough the entire CFL lamp. The inner end portion of the sleeve is clamped between the lamp base and a socket when the lamp is screwed into the socket, thereby to support the sleeve adjacent to the lamp.

### RELATED APPLICATIONS

This application claims the benefit of U.S. Provisional Application No. 61/138,214 filed Dec. 17, 2008, titled CFL Color Sleeves, by the same inventor, the entire disclosure of which is incorporated by reference.

### BACKGROUND OF THE INVENTION

Compact Fluorescent Bulbs (CFLs) have become very popular because of their relatively low energy usage for the amount of light output. One drawback of a CFL is the harsh, antiseptic light that it casts. This invention addresses that issue. Other inventions have also, as follows.

U.S. Pat. No. 7,434,961 to Bernhardt, et al. shows a device for enhancing the appearance of a CFL. The device is a cover that clips onto the outer end of a spiral (or double tube) CFL to change the color of the light coming out in that direction.

It is known to completely enclose a CFL in a reflector/cover lens to attempt to replicate a standard reflector (R) or parabolic (PAR) type bulb as used in recessed fixtures, as shown in U.S. Pat. No. D532,124.

U.S. Pat. No. 5,546,291 to Simes shows a conversion kit assembly for a CFL bulb including a glass envelope that changes the appearance of the bulb as well as the illumination produced by the bulb.

U.S. Pat. No. 4,785,384 to Zwald et al. shows a cover for use over a twin-tube gas discharge lamp, or for use over a fluorescent lamp, that simulates the appearance (including color) of a gaslight.

U.S. Pat. No. 5,980,068 to Yu shows a lamp shade that clips onto a spiral CFL to (a) protect the user from engaging a hot bulb and (b) enable the user to grasp and rotate the cooler shade (rather than the hot bulb) to remove the bulb from its fixture.

### BRIEF DESCRIPTION OF THE DRAWINGS

FIG. 1 is an exploded perspective view illustrating a sleeve in accordance with the invention, a CFL with which the sleeve is to be associated, and an electrical socket for receiving the CFL;

FIG. 2 is an assembled view of the sleeve, CFL, and socket; and

FIG. 3 is a schematic view showing a plurality of the sleeves being stacked for packaging and shipment.

### DETAILED DESCRIPTION

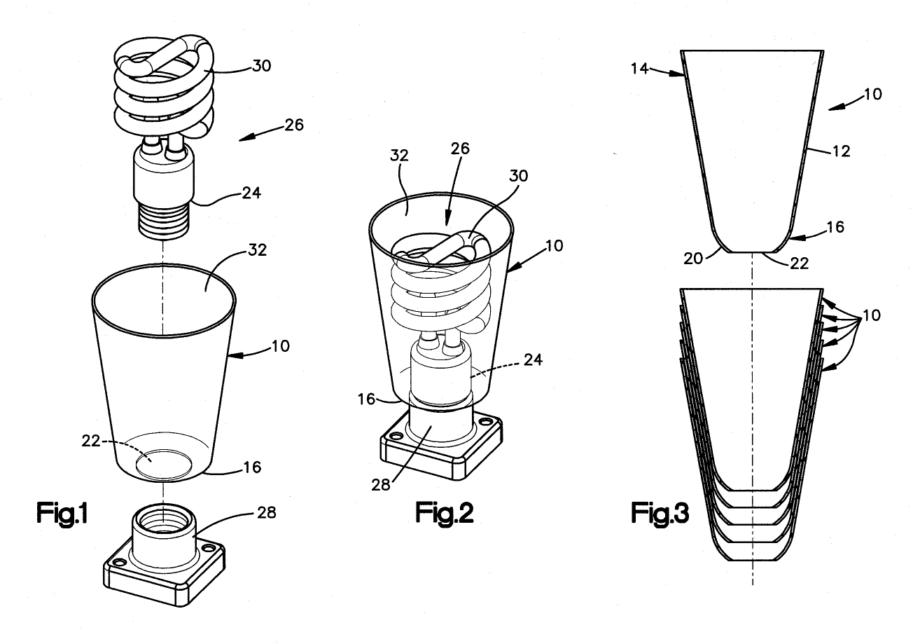

The invention relates to lamps and light fixtures. Specifically, this invention provides a color sleeve for modifying the light output of a CFL. The invention is applicable to color sleeves of varying and different constructions. As representative of the invention, FIG. 1 illustrates a color sleeve 10 that is a first embodiment of the invention.

The sleeve 10 has a side wall 12, an outer end portion 14 and an inner end portion 16. The side wall 12 in the illustrated embodiment is generally cone-shaped, or conical. Because the side wall 12 is conical, the outer end portion 14 is larger in diameter than the inner end portion 16. In other embodiments, the sleeve 10 might have a different configuration—for example, may be cylindrical rather than conical.

The inner end portion 16 of the sleeve 10 includes an inner end wall 20 that curves inward from the side wall 12. The inner end wall 20 has a lip 21 defining an inner end opening 22 through which the base 24 of the CFL (or lamp) 26 can be inserted. The lamp 26 is a standard size with a standard size base 24 that can be screwed into a standard sized socket 28, and a standard sized bulb portion 30. Exemplary dimensions are set forth below. The inner end opening 22 of the sleeve 10 is sized to fit closely around the base 24 of the lamp 26, as shown.

The outer end portion 14 of the sleeve 10, in the illustrated embodiment, is an end portion of the side wall 12 and has an outer end opening 32 through which the entire lamp 26 can be passed. Because the side wall 12 is conical, the outer end opening 32 is larger in diameter than the inner end opening 22.

The sleeve 10 may be made from a transparent to semi-transparent polymer that can withstand the heat of the lamp 26. A clear, tinted, lightweight, heat-resistant plastic is a preferred material. The sleeve 10 is tinted or otherwise manufactured so that it changes the hue of the light emanating from the lamp 26 and its associated fixture. This is designed to eliminate the “fluorescent” quality of the light. In addition, the color can be selected to change the “mood” of the ambient surroundings. Various different colors can be provided for different room characteristics, moods, etc.

In use, the sleeve 10 is placed around the lamp 26 by inserting the base 24 of the lamp 26 through the outer end opening 32 of the sleeve 10 and then through the sleeve and out the inner end opening 22. The sleeve 10 and lamp 26 are then associated with the electrical socket 28 by screwing the base 24 of the lamp 26 into the socket to provide a source of electrical current for the lamp.

When the lamp 26 is screwed into the socket 28, the lip 21 on the inner end portion 16 of the sleeve 10 is clamped between the lamp and the socket, to retain and orient the sleeve 10 in place on the socket.

When the lamp 26 is then lit, most of the light that emanates from the lamp 26 passes through the sleeve 10. Only a very small percentage of the light exits from the outer end opening 32 of the sleeve 10. As a result, the fixture including the lamp 26 provides illumination that is colored or tinted as desired, changed from the standard hue of the CFL.

The dimensions of the sleeve 10 are selected so that the sleeve 10 encloses the lamp 26 fairly closely, without being so close that it touches anywhere other than where it is clamped against the base 24. The side wall 12 of the sleeve 10 is disposed radially outward of the bulb portion 30 of the lamp 26. The side wall 12 extends longitudinally over the entire length of the bulb portion 30 of the lamp 26. In addition, the dimensions of the sleeve 10 may be selected so that the sleeve 10 will fit within some standard lampshades.

In one embodiment, the sleeve 10 has the following dimensions: Length, 4.5 inches; diameter at outer end portion, 2.9 inches; diameter of inner end opening, 1.07 inches. A sleeve with these dimensions will fit a standard 13 watt spiral CFL.

The sleeve 10 can alternatively be used with bulbs other than CLF lamps. FIG. 3 illustrates how a plurality of sleeves 10 can be stacked for ease of packaging and shipment.

1. A lamp sleeve for changing the hue of light emanating from a standard size CFL lamp that can be screwed into a standard size socket, the sleeve comprising:
a side wall having an inner end portion and an outer end portion;
the inner end portion having an inner end opening sized to receive therethrough only the base of the lamp;
the outer end portion having an outer end opening sized to receive therethrough the entire lamp;
the inner end portion of the sleeve being clamped between the lamp base and the socket when the lamp is screwed into the socket, thereby to support the sleeve adjacent to the lamp.

2. A lamp sleeve as set forth in claim 1 wherein the side wall is conical and the outer end opening is larger in diameter than the inner end opening.

3. A lamp sleeve as set forth in claim 1 wherein the sleeve is made from a lightweight, heat-resistant, transparent to semi-transparent tinted polymer.

4. A lamp sleeve as set forth in claim 1 wherein the length of the side wall is selected to be disposed radially outward of the bulb portion of the lamp over the entire length of the bulb portion of the lamp.

5. A lamp sleeve as set forth in claim 4 wherein the side wall is conical and the outer end opening is larger in diameter than the inner end opening.

6. A lamp sleeve for changing the hue of light emanating from a standard size CFL lamp that can be screwed into a standard size socket, the sleeve comprising:
a conical side wall having an inner end portion and an outer end portion;
the inner end portion having an inner end opening sized to receive therethrough only the base of the lamp;
the outer end portion having an outer end opening sized to receive therethrough the entire lamp;
the inner end portion of the sleeve being clamped between the lamp base and the socket when the lamp is screwed into the socket, thereby to support the sleeve adjacent to the lamp with the sleeve side wall being disposed radially outward of the bulb portion of the lamp over the entire length of the bulb portion of the lamp; and
the sleeve being made from a lightweight, heat-resistant, transparent to semi-transparent tinted polymer.
